(19) United States
(12) Patent Application Publication
(10) Pub. No.: US 2020/0077378 A1
(43) Pub. Date: Mar. 5, 2020

(54) COMMUNICATIONS NETWORK ARCHITECTURE AND SIGNALING TRANSPORT METHOD AND APPARATUS

(71) Applicant: BEIJING XIAOMI MOBILE SOFTWARE CO., LTD., Beijing (CN)

(72) Inventor: Yang LIU, Beijing (CN)

(73) Assignee: BEIJING XIAOMI MOBILE SOFTWARE CO., LTD., Beijing (CN)

(21) Appl. No.: 16/679,131

(22) Filed: Nov. 8, 2019

Related U.S. Application Data
(63) Continuation of application No. PCT/CN2017/086383, filed on May 27, 2017.

(51) Int. Cl. H04W 72/04

(52) U.S. Cl. CPC H04W 72/0406; H04W 88/10

(57) ABSTRACT

A network architecture includes: at least one controllable device and multi-mode base station, the multi-mode base station at least supporting 5G communications and point-to-point communications; the controllable device and the multi-mode base station communicate with one another on the basis of point-to-point communications. The multi-mode base station can communicate normally with a terminal on the basis of 5G communications, and communicate with the controllable device on the basis of point-to-point communications; thereby providing a solution of a network architecture combining a 5G system communicating with a controllable device.

### CROSS-REFERENCE TO RELATED APPLICATION

This application is a Continuation of International Application No. PCT/CN2017/086383 filed on May 27, 2017, the disclosure of which is hereby incorporated reference in its entirety.

### BACKGROUND

At present, applications of unmanned aerial system (UAS, e.g., drones) are becoming more and more extensive. In the related art, if an LTE (Long-Term Evolution) communication system is used to communicate with a drone, a bandwidth and delay required for current services of the drone cannot be ensured, and if a point-to-point communication system is used to communicate with the drone. However, interaction with a network side in real time may be difficult to achieve.

### SUMMARY

The present disclosure relates to the field of communications, and in particular, to a communication network architecture, a signaling transmission method, and an apparatus.

Embodiments of the present disclosure provide a communication network architecture, a signaling transmission method, and an apparatus.

According to a first aspect of an embodiment of the present disclosure, a communication network architecture is provided, including: at least one controllable device and a multi-mode base station, the multi-mode base station at least supporting a 5G communication mode and a point-to-point communication mode,

wherein the controllable device and the multi-mode base station communicate with one another on the basis of the point-to-point communication mode.

In some embodiments, the multi-mode base station is a common mode base station of a 5G communication system and a point-to-point communication system.

In some embodiments, the communication network architecture further includes at least one communication node,

wherein, the communication node and the controllable device communicate with one another on the basis of the point-to-point communication mode;

the communication node and the multi-mode base station communicate with one another on the basis of the 5G communication mode.

In some embodiments, the communication node and the controllable device communicate with one another by using a wireless communication frequency band corresponding to the 5G communication system.

In some embodiments, the communication node and the multi-mode base station communicate with one another through a preset communication interface.

In some embodiments, when the number of the controllable devices is multiple, the controllable devices communicate with each other on the basis of the point-to-point communication mode.

According to a second aspect of various embodiments of the present disclosure, a signaling transmission method is provided, which is used in the controllable device in the communication network architecture described in the above first aspect, the method including:

receiving a control signaling transmitted by a multi-mode base station on the basis of a point-to-point communication mode, wherein the control signaling is a signaling for controlling the controllable device and transmitted by a terminal to the multi-mode base station;

performing a corresponding operation according to the control signaling.

In some embodiments, the method further includes:

receiving a control signaling transmitted by the multi-mode base station to the communication node and forwarded by a communication node in the communication network architecture on the basis of the point-to-point communication mode, wherein the control signaling is a signaling for controlling the controllable device and transmitted by a terminal to the multi-mode base station;

after receiving the control signaling forwarded by the communication node, performing the step of the performing a corresponding operation according to the control signaling.

In some embodiments, when the control signaling is used to control the controllable device to perform a feedback operation of information, the method further includes:

transmitting feedback information collected according to the control signaling to the multi-mode base station on the basis of the point-to-point communication mode, so that the multi-mode base station transmits the feedback information to the terminal; or

transmitting the feedback information collected according to the control signaling to the communication node on the basis of the point-to-point communication mode, so that after the communication node transmits the feedback information to the multi-mode base station on the basis of the 5G communication mode, the feedback information is transmitted by the multi-mode base station to the terminal.

According to a third aspect of various embodiments of the present disclosure, a signaling transmission method is provided, which is used in a multi-mode base station in a communication network architecture described in the above first aspect, the method including:

receiving a control signaling transmitted by a terminal, wherein the control signaling is a signaling for controlling a controllable device in the communication network architecture; and

transmitting the control signaling to the controllable device on the basis of a point-to-point communication mode, so that the controllable device performs a corresponding operation according to the control signaling.

In some embodiments, after the receiving a control signaling transmitted by a terminal, the method further includes:

transmitting the control signaling to a communication node in the network architecture on the basis of a 5G communication mode, so that the communication node forwards the control signaling to the controllable device on the basis of the point-to-point communication mode.

In some embodiments, when the control signaling is used to control the controllable device to perform a feedback operation of information, the method further includes:

receiving the feedback information transmitted by the controllable device to the multi-mode base station on the basis of the point-to-point communication mode, wherein the feedback information is information collected by the controllable device on the basis of the control signaling; and

transmitting the feedback information to the terminal.

In some embodiments, when the control signaling is used to control the controllable device to perform a feedback operation of information, the method further includes:

receiving the feedback information forwarded by the communication node in the communication network architecture to the multi-mode base station on the basis of the 5G communication mode; wherein the feedback information is information collected by the controllable device on the basis of the control signaling; and

transmitting the feedback information to the terminal.

According to a fourth aspect of various embodiments of the present disclosure, a signaling transmission apparatus is provided, which is used in the controllable device in the communication network architecture described in the above first aspect, the apparatus including:

a first receiving module, configured to receive a control signaling transmitted by a multi-mode base station on the basis of a point-to-point communication mode, wherein the control signaling is a signaling for controlling the controllable device and transmitted by a terminal to the multi-mode base station; and

a performing module, configured to perform a corresponding operation according to the control signaling.

In some embodiments, the apparatus further includes:

a second receiving module, configured to receive a control signaling transmitted by the multi-mode base station to the communication node and forwarded by a communication node in the communication network architecture on the basis of the point-to-point communication mode, wherein the control signaling is a signaling for controlling the controllable device and transmitted by a terminal to the multi-mode base station; and

a control module, configured to control the performing module to perform a corresponding operation according to the control signaling after the second receiving module receives the control signaling forwarded by the communication node.

In some embodiments, the device further includes any one of following modules:

a first transmitting module, configured to, when the control signaling is used to control the controllable device to perform a feedback operation of information, transmit feedback information collected according to the control signaling to the multi-mode base station on the basis of the point-to-point communication mode, so that the multi-mode base station transmits the feedback information to the terminal;

a second transmitting module, configured to, when the control signaling is used to control the controllable device to perform a feedback operation of information, transmit the feedback information collected according to the control signaling to the communication node on the basis of the point-to-point communication mode, so that after the communication node transmits the feedback information to the multi-mode base station on the basis of the 5G communication mode, the feedback information is transmitted by the multi-mode base station to the terminal.

According to a fifth aspect of various embodiments of the present disclosure, a signaling transmission apparatus is provided, which is used in a multi-mode base station in the communication network architecture described in the above first aspect, the apparatus including:

a third receiving module, configured to receive a control signaling transmitted by a terminal, wherein the control signaling is a signaling for controlling a controllable device in the communication network architecture; and

a third transmitting module, configured to transmit the control signaling to the controllable device on the basis of a point-to-point communication mode, so that the controllable device performs a corresponding operation according to the control signaling.

In some embodiments, the apparatus further includes:

a fourth transmitting module, configured to transmit the control signaling to a communication node in the network architecture on the basis of a 5G communication mode, so that the communication node forwards the control signaling to the controllable device on the basis of the point-to-point communication mode.

In some embodiments, the apparatus further includes:

a fourth receiving module, configured to receive the feedback information transmitted by the controllable device to the multi-mode base station on the basis of the point-to-point communication mode, wherein the feedback information is information collected by the controllable device on the basis of the control signaling; and

a fifth transmitting module, configured to transmit the feedback information to the terminal.

In some embodiments, the apparatus further includes:

a fifth receiving module, configured to receive the feedback information forwarded by the communication node in the communication network architectures to the multi-mode base station on the basis of the 5G communication mode, wherein the feedback information is information collected by the controllable device on the basis of the control signaling; and

a sixth transmitting module, configured to transmit the feedback information to the terminal.

According to a sixth aspect of various embodiments of the present disclosure, a computer readable storage medium storing a computer program is provided, wherein the computer program is for performing the signaling transmission method of the second aspect described above.

According to a seventh aspect of various embodiments of the present disclosure, a computer readable storage medium storing a computer program is provided, wherein the computer program is for performing the signaling transmission method of the third aspect described above.

According to an eighth aspect of various embodiments of the present disclosure, a signaling transmission apparatus is provided, wherein the apparatus is used in the controllable device in the communication network architecture of the second aspect described above, including:

a processor; and

a memory for storing instructions executable by the processor;

wherein the processor is configured to:

receive a control signaling transmitted by a multi-mode base station on the basis of a point-to-point communication mode, wherein the control signaling is a signaling for controlling the controllable device and transmitted by a terminal to the multi-mode base station; and

perform a corresponding operation according to the control signaling.

According to a ninth aspect of various embodiments of the present disclosure, a signaling transmission apparatus is provided, wherein the apparatus is used in a multi-mode base station in the communication network architecture of the third aspect described above, including:

a processor; and

a memory for storing signals executable by the processor;

wherein the processor is configured to:

receiving a control signaling transmitted by a terminal, wherein the control signaling is a signaling for controlling a controllable device in the communication network architecture; and

transmitting the control signaling to the controllable device on the basis of a point-to-point communication mode, so that the controllable device performs a corresponding operation according to the control signaling.

It should be understood that the above general description and the following detailed description are merely exemplary and explanatory and should not be construed as limiting of the disclosure.

### BRIEF DESCRIPTION OF THE DRAWINGS

The accompanying drawings, which are incorporated in the specification and constitute a part of the specification, show exemplary embodiments of the present disclosure. The drawings along with the specification explain the principles of the present disclosure.

FIG. 1 is a schematic diagram of a communication network architecture according to some embodiments.

FIG. 2 is a schematic diagram of another communication network architecture according to some embodiments.

FIG. 3 is a schematic diagram of another communication network architecture, according to some embodiments.

FIG. 4 is a flowchart of a signaling transmission method according to some embodiments.

FIG. 5 is a flowchart of another signaling transmission method according to some embodiments.

FIG. 6A is a flowchart of another signaling transmission method according to some embodiments.

FIG. 6B is a flowchart of another signaling transmission method according to some embodiments.

FIG. 7 is a flowchart of another signaling transmission method according to some embodiments.

FIG. 8 is a flowchart of another signaling transmission method according to some embodiments.

FIG. 9 is a flowchart of another signaling transmission method according to some embodiments.

FIG. 10 is a flowchart of another signaling transmission method according to some embodiments.

FIG. 11 is a flowchart of another signaling transmission method according to some embodiments.

FIG. 12 is a flowchart of another signaling transmission method according to some embodiments.

FIG. 13 is a block diagram of a signaling transmission apparatus according to some embodiments.

FIG. 14 is a block diagram of another signaling transmission apparatus according to some embodiments.

FIG. 15A is a block diagram of another signaling transmission apparatus according to some embodiments.

FIG. 15B is a block diagram of another signaling transmission apparatus according to some embodiments.

FIG. 16 is a block diagram of another signaling transmission apparatus according to some embodiments.

FIG. 17 is a block diagram of another signaling transmission apparatus according to some embodiments.

FIG. 18 is a block diagram of another signaling transmission apparatus according to some embodiments.

FIG. 19 is a block diagram of another signaling transmission apparatus according to some embodiments.

FIG. 20 is a schematic structural diagram of a signaling transmission apparatus according to some embodiments of the present disclosure.

FIG. 21 is a schematic structural diagram of another signaling transmission apparatus according to some embodiments of the present disclosure.

### DETAILED DESCRIPTION

Exemplary embodiments will be described in detail herein, examples of which are illustrated in the accompanying drawings. The following description refers to the same or similar elements in the different figures unless otherwise indicated. The embodiments described in the following exemplary embodiments do not represent all embodiments consistent with the present disclosure. Instead, they are merely examples of devices and methods consistent with aspects of the disclosure as detailed in the appended claims.

The terms used in the present disclosure are for the purpose of describing particular embodiments only, and are not intended to limit the present disclosure. As used in the present disclosure and the appended claims, the singular forms “a”, “the” and “said” are intended to include the plural forms as well, unless the context clearly indicates otherwise. It should also be understood that the term “and/or” as used herein refers to and encompasses any and all possible combinations of one or more of the associated listed items.

It should be understood that although the terms first, second, third, etc. may be used to describe various information in the present disclosure, such information should not be limited to these terms. These terms are only used to distinguish the same type of information from each other. For example, the first information may also be referred to as second information without departing from the scope of the present disclosure. Similarly, the second information may also be referred to as the first information. Depending on the context, the word “if” as used herein may be interpreted as “when” or “upon” or “in response to determining”.

5G, namely NR (New Radio) network related standardization is being carried out in 3GPP (3rd Generation Partnership Project). In the 5G system, there is no solution for communicating with the drone currently.

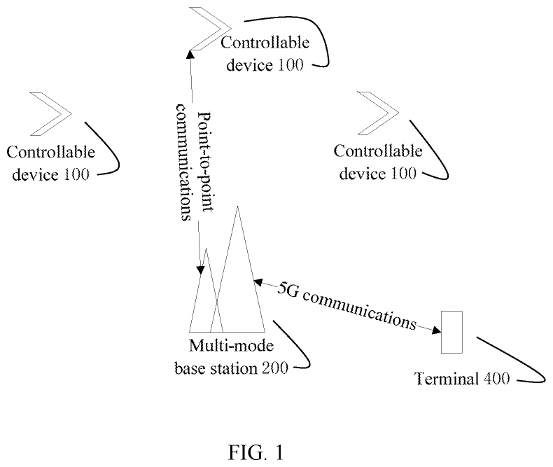

An embodiment of the present disclosure provides a communication network architecture. As shown in FIG. 1, the communication network architecture includes at least one controllable device 100 and a multi-mode base station 200.

In some embodiments, the controllable device 100 can be a robot or a UAS (e.g., drone), the multi-mode base station 200 at least supports a 5G communication mode and a point-to-point communication mode.

In some embodiments, the multi-mode base station 200 can be a common mode base station of a 5G communication system and a point-to-point communication system. In the related art, the common mode base station refers to that different communication systems adopt the same chassis or cabinet. That is, different communication systems can adopt the same BBU (Building Baseband Unit) and RRU (Remote Radio Unit).

In some embodiments of the present disclosure, the multi-mode base station 200 can employ a common mode base station of a 5G communication system and a point-to-point communication system.

In the communication network architecture shown in FIG. 1, the multi-mode base station 200 can also perform normal communication with the terminal 400 on the basis of the 5G communication mode. In addition, the multi-mode base station 200 and the controllable device 100 communicate with one another on the basis of the point-to-point communication mode, such as a PC5 mode.

That is, in the communication network architecture provided by various embodiments of the present disclosure, the multi-mode base station 200 can communicate with the controllable device 100 by using a separate frequency, without affecting the normal wireless communication between the multi-mode base station 200 and the terminal 400.

In the above communication network architecture, the multi-mode base station can perform normal communication with the terminal on the basis of the 5G communication mode, and communicate with the controllable device on the basis of the point-to-point communication mode, thereby providing a solution for a network architecture that performs the communication with the controllable device in combination with the 5G system.

Considering that the controllable device 100 and the multi-mode base station 200 communicate with one another on the basis of the point-to-point communication mode, one multi-mode base station 200 can communicate with one controllable device 100 at a certain time point. However, this will result in a waste of 5G system resources.

Therefore, another communication network architecture is further provided in various embodiments of the present disclosure. As shown in FIG. 2, FIG. 2 is another communication network architecture on the basis of the embodiments shown in FIG. 1, further including: at least one communication node 300.

In some embodiments, corresponding to the controllable device 100, the communication node 300 can be a small base station; corresponding to the multi-mode base station 200, the communication node 300 can be a communication hotspot device.

In the above communication network architecture, in order to ensure the normal communication between the communication node 300 and the controllable device 100, the communication node 300 and the controllable device 100 can communicate with one another using a different frequency band and communication standard from those of the wireless communication in the related art. In some embodiments, the communication node 300 and the controllable device 100 can communicate with one another on the basis of the point-to-point communication mode, such as a PC5 manner; and the communication node 300 and the controllable device 100 communicate with one another using the wireless communication frequency band corresponding to the 5G communication system.

The communication node 300 and the multi-mode base station 200 can communicate with one another on the basis of the 5G communication mode.

In the above communication network architecture, one communication node 300 can perform the point-to-point communication with one controllable device 100 at a certain time point, while each communication node 300 can perform 5G communication with the multi-mode base station 200 through the preset communication interface 500, and the number of communication nodes performing communication with the multi-mode base station 200 can be multiple, thereby achieving the purpose of simultaneously communicating with a plurality of controllable devices 100 in combination with the 5G system at the same time point.

In some embodiments, the preset communication interface between the communication node 300 and the multi-mode base station 200 can be defined as a dN interface. The preset communication interfaces can connect with each other in a wireless manner or in a wired manner, and the preset communication interface supports 5G or a newly defined communication standard in the future. Among them, when the connection is conducted in a wired manner, the connection can be conducted through an optical fiber.

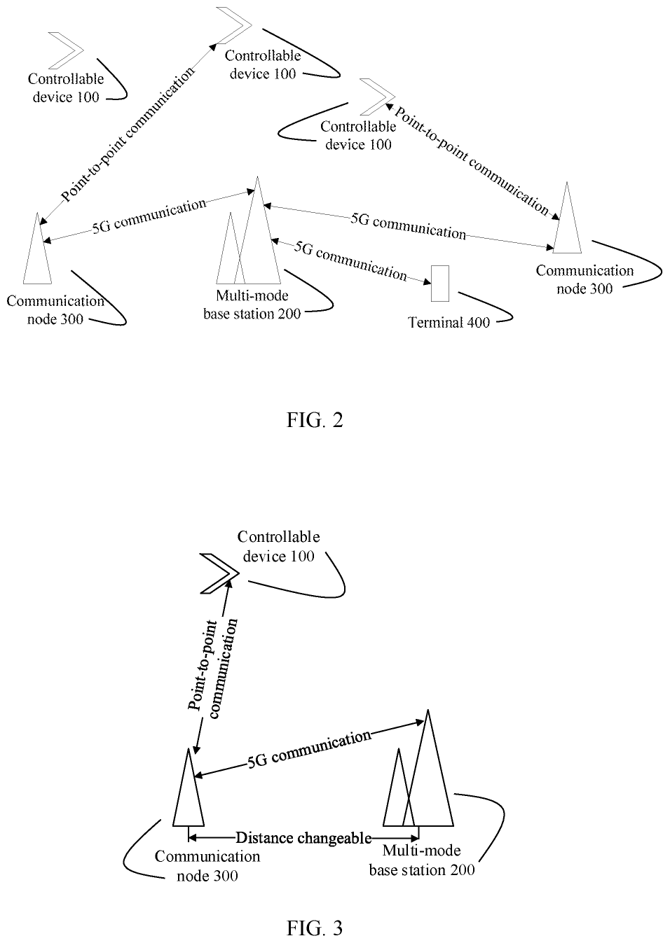

In some applications, when the communication node 300 and the multi-mode base station 200 are connected in a wireless manner, the location of the communication node 300 can be mobile. As shown in FIG. 3, in some embodiments, the communication node 300 can be disposed on a controller of the controllable device 100. Real-time communication with the controllable device 100 and the multi-mode base station 200 can be performed through the communication node 300.

When the communication node 300 and the multi-mode base station 200 are connected in a wired manner, the location of the communication node 300 can be fixed. In some embodiments, the communication node 300 can be disposed in a public place, such as a sports park or the like. The public can communicate with the controllable device 100 and the multi-mode base station 200 in real time through the communication node 300.

In the above embodiment, the communication network architecture can further include at least one communication node, and the communication node and the controllable device communicate with one another on the basis of the point-to-point communication mode, such as a PC5 manner, and the communication node and the multi-mode base station communicate with one another on the basis of the 5G communication mode. With the above communication network architecture, it is possible to communicate with more controllable devices through different communication nodes at the same time point, which achieves high availability.

In some embodiments of the present disclosure, in any of the above communication network architectures, in some embodiments, when the number of the controllable devices 100 is multiple, the controllable devices 100 can communicate with each other on the basis of the point-to-point communication mode. In some embodiments, the relative position information and the like between the controllable device 100 and the other controllable device 100 can be automatically obtained by the controllable device 100 on the basis of the point-to-point communication mode. When the relative distance value indicated by the relative position information is less than a preset distance value, the controllable device 100 automatically performs eluding, thereby avoiding collision between the controllable devices 100 and better assisting users in locating and coordinating the controllable devices, etc.

Various embodiments of the present disclosure further provide a signaling transmission method, which can be used in the controllable device in the above communication network architecture.

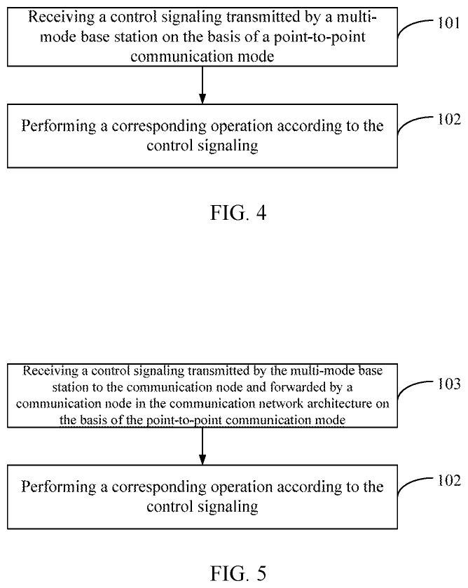

FIG. 4 is a signaling transmission method according to an embodiment of the present application, and includes the following steps.

In step 101, a control signaling transmitted by a multi-mode base station on the basis of a point-to-point communication mode is received, wherein the control signaling is a signaling for controlling the controllable device and transmitted by a terminal to the multi-mode base station.

In step 102, a corresponding operation is performed according to the control signaling.

In the above embodiment, after receiving the control signaling transmitted by the multi-mode base station on the basis of the point-to-point communication mode, the controllable device can perform the corresponding operation according to the control signaling.

In some embodiments, the control signaling is a signaling for controlling the controllable device and transmitted by the terminal to the multi-mode base station. Through the above processes, the multi-mode base station performs the point-to-point communication with the controllable device directly, thereby realizing the real-time communication with the controllable device in the 5G network system, and further, controlling the controllable device to perform the corresponding operation in real time.

As for the above step 101, in some embodiments, the terminal can be a smart phone, a computer, a personal digital assistant (PDA), or the like. The terminal can be bound to the controllable device in advance, and further, the terminal generates the control signaling for controlling the controllable device according to the related art, and transmits the control signaling to the multi-mode base station. The multi-mode base station can directly receive the control signaling.

Further, after receiving the control signaling, the multi-mode base station can transmit the control signaling to the controllable device on the basis of the point-to-point communication mode, such as a PC5 manner.

As for the above step 102, after receiving the control signaling transmitted by the multi-mode base station on the basis of the point-to-point communication mode, the controllable device can perform an operation corresponding to the control signaling.

In some embodiments, the operations include, but not limited to, takeoff, landing, altitude up or down, flying according to a preset trajectory, feedback operation of information, and the like. The feedback information collected by the controllable device can be height measurement information, geological exploration information, real-time image information, or other information that needs to be collected.

Various embodiments of the present disclosure further provide another signaling transmission method.

FIG. 5 is another signaling transmission method on the basis of various embodiments shown in FIG. 4, which can further include the following steps.

In step 103, a control signaling transmitted by the multi-mode base station to the communication node and forwarded by a communication node in the communication network architecture on the basis of the point-to-point communication mode is received, wherein the control signaling is a signaling for controlling the controllable device and transmitted by a terminal to the multi-mode base station.

In this step, after the terminal transmits the control signaling to the multi-mode base station according to the related art, the multi-mode base station can determine a communication node corresponding to the controllable device in the communication network architecture, and transmit the control signaling to the communication node on the basis of the 5G communication mode.

Further, the control node forwards the control signaling to the controllable device on the basis of the point-to-point communication mode.

After receiving the control signaling forwarded by the communication node, the controllable device can perform the step 102 to perform the corresponding operation according to the control signaling.

In some embodiments of the present disclosure, in some embodiments, the controllable device can further perform the corresponding operation according to a control instruction forwarded by the communication node on the basis of the point-to-point communication mode. In the above process, the communication node performs the point-to-point communication with the controllable device, while the communication node performs the 5G communication with the multi-mode base station. The purpose of real-time communication with the controllable device in the 5G network system is also achieved.

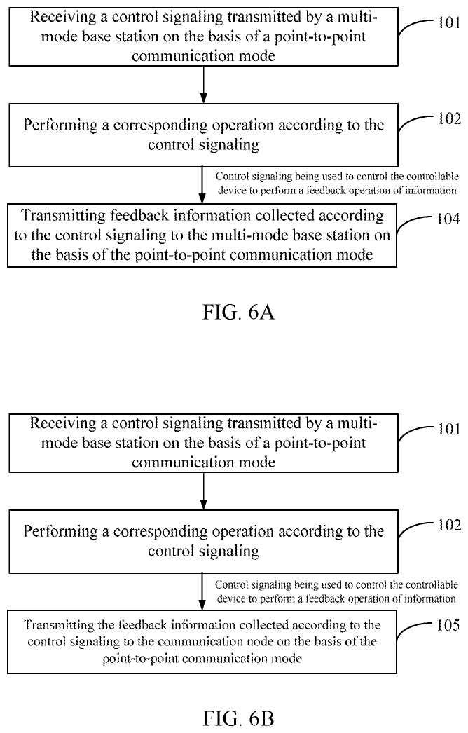

In some embodiments of the present disclosure, when the control signaling is used to control the controllable device to perform a feedback operation of information, the method is shown in FIG. 6A, and FIG. 6A is another signaling transmission method on the basis of the embodiments shown in FIG. 4, which can further include the following steps.

In step 104, feedback information collected according to the control signaling is transmitted to the multi-mode base station on the basis of the point-to-point communication mode, so that the multi-mode base station transmits the feedback information to the terminal.

In this step, the controllable device collects the feedback information on the basis of the control signaling according to the related art. In some embodiments, the feedback information can be height measurement information, geological exploration information, real-time image information, or other information that needs to be collected.

After the controllable device collects the feedback information, the feedback information can be directly transmitted to the multi-mode base station according to the point-to-point communication mode, such as a PC5 manner. After receiving the feedback information, the multi-mode base station can transmit the feedback information to the terminal according to the related art.

For example, the control signaling is to control the controllable device to perform aerial photography, and the controllable device can transmit the photographed real-time image to the multi-mode base station on the basis of a point-to-point communication mode, and then the multi-mode base station transmits the photographed real-time image to the terminal. The terminal displays the real-time image according to the related art. Through the above processes, the image acquired by the controllable device during aerial photography can be displayed to the user in real time, and the real-time communication between the controllable device and the terminal is realized in the 5G system.

In some embodiments of the present disclosure, when the control signaling is used to control the controllable device to perform a feedback operation of information, the method is shown in FIG. 6B, and FIG. 6B is another signaling transmission method on the basis of the embodiments shown in FIG. 4, which can further include the following steps.

In step 105, the feedback information collected according to the control signaling is transmitted to the communication node on the basis of the point-to-point communication mode, so that after the communication node transmits the feedback information to the multi-mode base station on the basis of the 5G communication mode, the feedback information is transmitted by the multi-mode base station to the terminal.

In this step, after collecting the feedback information on the basis of the control signaling according to the related art, the controllable device can transmit the feedback information to the corresponding communication node on the basis of the point-to-point communication mode, such as the PC5 mode. Further, the feedback information is transmitted by the communication node to the multi-mode base station on the basis of the 5G communication mode. After receiving the feedback information, the multi-mode base station transmits the feedback information to the terminal.

Through the above process, the real-time communication between the controllable device and the terminal is realized in the 5G system as well.

Various embodiments of the present disclosure also provide another signaling transmission method, which can be used in a multi-mode base station in the above communication network architecture.

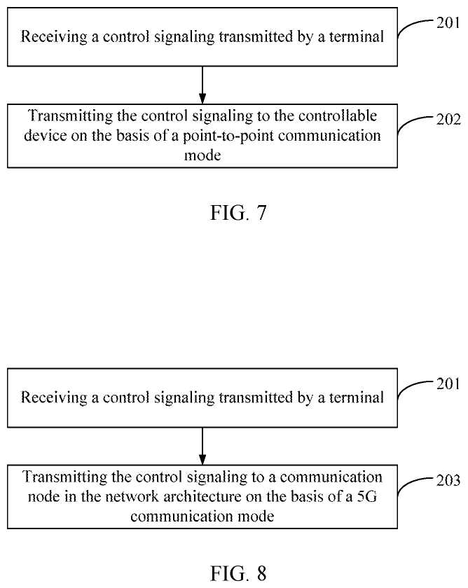

FIG. 7 is another signaling transmission method according to an embodiment of the present application, and includes the following steps.

In step 201, a control signaling transmitted by a terminal is received, wherein the control signaling is a signaling for controlling a controllable device in the communication network architecture.

In step 202, the control signaling is transmitted to the controllable device on the basis of a point-to-point communication mode, so that the controllable device performs a corresponding operation according to the control signaling.

In the above embodiment, after receiving the control signaling transmitted by the terminal, the multi-mode base station can transmit the control signaling to the controllable device on the basis of the point-to-point communication mode, so that the controllable device can perform the corresponding operation according to the control signaling. Through the above processes, real-time communication with the controllable device is realized in the 5G system, and further, real-time control of the controllable device can be realized through the terminal.

As for the above step 201, after generating the control signaling for controlling the controllable device according to the related art, the terminal can transmit the control signaling to the multi-mode base station, and the multi-mode base station directly receives the control signaling.

In the above step 202, after receiving the control signaling transmitted by the terminal, the multi-mode base station can directly transmit the control signaling to the controllable device on the basis of the point-to-point communication mode, such as a PC5 manner.

After receiving the control signaling, the controllable device can perform a corresponding operation according to the control signaling.

Various embodiments of the present disclosure further provide another signaling transmission method, which is shown in FIG. 8.

FIG. 8 is another signaling transmission method on the basis of the embodiments shown in FIG. 7. After the step 201, the following steps can also be included.

In step 203, the control signaling is transmitted to a communication node in the network architecture on the basis of a 5G communication mode, so that the communication node forwards the control signaling to the controllable device on the basis of the point-to-point communication mode.

In this step, after receiving the control signaling transmitted by the terminal, the base station can transmit the control signaling to the communication node on the basis of the 5G communication mode, and the communication node subsequently forwards the control signaling to the controllable device on the basis of the point-to-point communication mode.

After receiving the control signaling, the controllable device also performs the corresponding operation according to the control signaling.

In the above embodiment, the purpose of the real-time communication with the controllable device is also achieved in the 5G system, and further, the real-time control of the controllable device can be achieved through the terminal.

Various embodiments of the present disclosure further provide another signaling transmission method.

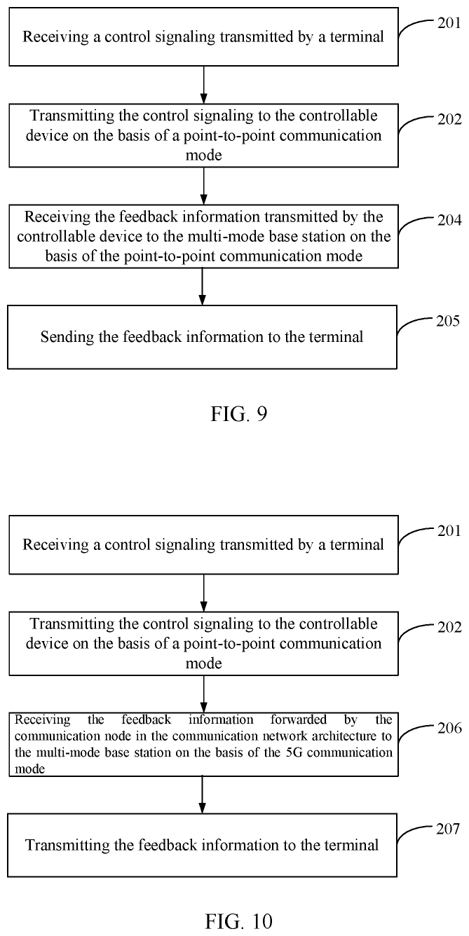

FIG. 9 is another signaling transmission method on the basis of the embodiments shown in FIG. 7, which can further include the following steps.

In step 204, the feedback information transmitted by the controllable device to the multi-mode base station on the basis of the point-to-point communication mode is received, wherein the feedback information is information collected by the controllable device on the basis of the control signaling.

In this step, when the control signaling is used to control the controllable device to perform a feedback operation of information, the controllable device can perform information collection according to the control signaling, obtain feedback information, and then transmit the feedback information to the multi-mode base station on the basis of the point-to-point communication mode. The multi-mode base station directly receives the feedback information.

In step 205, the feedback information is transmitted to the terminal.

In this step, the multi-mode base station can transmit the feedback information to the terminal after receiving the feedback information according to the related art. The terminal can directly display the feedback information.

In the above embodiment, the multi-mode base station can directly receive the feedback information transmitted by the controllable device on the basis of the point-to-point communication, and then transmit the feedback information to the terminal. Through the above processes, the real-time communication between the controllable device and the terminal can be supported on the basis of the communication network architecture provided by some embodiments of the present disclosure.

Various embodiments of the present disclosure further provide another signaling transmission method.

FIG. 10 illustrates another signaling transmission method on the basis of the embodiments shown in FIG. 7, further including the following steps.

In step 206, the feedback information forwarded by the communication node in the communication network architecture to the multi-mode base station on the basis of the 5G communication mode is received, wherein the feedback information is information collected by the controllable device on the basis of the control signaling.

In this step, after collecting the feedback information according to the control signaling, the controllable device transmits the feedback information to the corresponding communication node on the basis of the point-to-point communication mode. Further, the multi-mode base station can receive the feedback information forwarded by the above communication node to the multi-mode base station on the basis of the 5G communication mode.

In step 207, the feedback information is transmitted to the terminal.

In this step, the multi-mode base station can transmit the feedback information to the terminal according to the related art on the basis of the 5G communication mode. After receiving the feedback information, the terminal can display the feedback information.

In the above embodiment, the multi-mode base station can receive the feedback information forwarded by the communication node on the basis of the 5G communication mode, and then transmit the feedback information to the terminal. Through the above processes, the real-time communication between the controllable device and the terminal can also be supported on the basis of the communication network architecture provided by various embodiments of the present disclosure.

Various embodiments of the present disclosure also provide another signaling transmission method, which can be used in any of the communication network architectures described above.

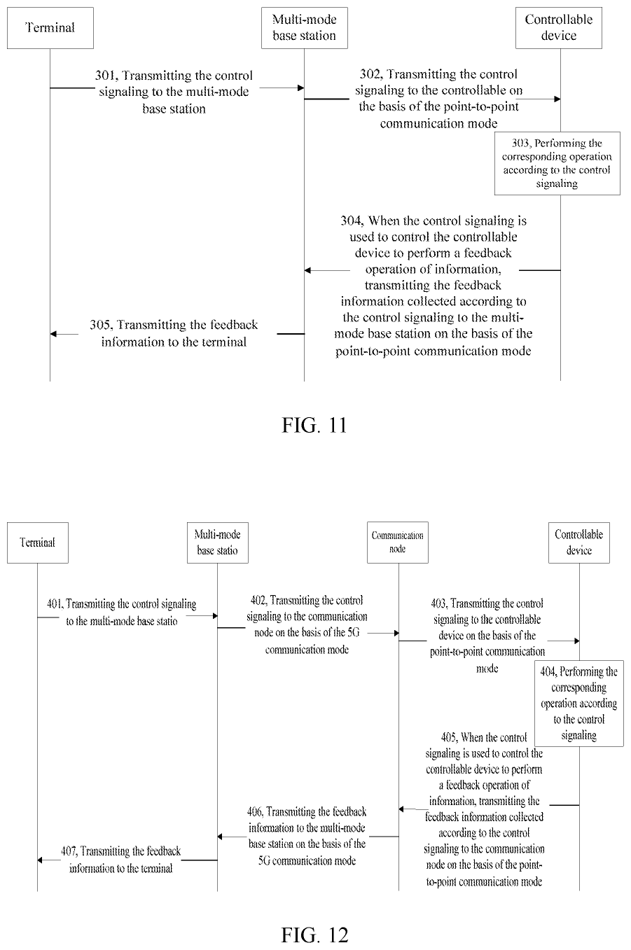

FIG. 11 is another signaling transmission method according to an embodiment of the present application, and includes the following steps.

In step 301, the terminal transmits the control signaling to the multi-mode base station, wherein the control signaling is a signaling for controlling a controllable device in the communication network architecture.

In step 302, the multi-mode base station transmits the control signaling to the controllable on the basis of the point-to-point communication mode.

In step 303, the controllable device performs the corresponding operation according to the control signaling.

In step 304, when the control signaling is used to control the controllable device to perform a feedback operation of information, the controllable device transmits the feedback information collected according to the control signaling to the multi-mode base station on the basis of the point-to-point communication mode.

In step 305, the multi-mode base station transmits the feedback information to the terminal.

In some embodiments, after receiving the feedback information, the terminal can perform the corresponding processing, for example, displaying the feedback information to the user.

In the above embodiment, the multi-mode base station can receive the control signaling transmitted by the terminal on the basis of the 5G communication mode, and then transmit the control signaling to the controllable device on the basis of the point-to-point communication mode, and the controllable device will perform the corresponding operation after receiving the control signaling. When the control signaling is used to control the controllable device to perform a feedback operation of information, the controllable device can transmit the feedback information to the multi-mode base station on the basis of the point-to-point communication mode as well, and then the multi-mode base station transmits the feedback information to the terminal. Through the above processes, the purpose of the real-time communication between the terminal and the controllable device is achieved.

Various embodiments of the present disclosure also provide another signaling transmission method, which can be used in any of the communication network architectures described above.

FIG. 12 is another signaling transmission method according to an embodiment of the present application, and includes the following steps.

In step 401, the multi-mode base station receives the control signaling transmitted by the terminal, wherein the control signaling is a signaling for controlling a controllable device in the communication network architecture.

In step 402, the multi-mode base station transmits the control signaling to the communication node on the basis of the 5G communication mode.

In step 403, the communication node forwards the control signaling to the controllable device on the basis of the point-to-point communication mode.

In step 404, the controllable device performs the corresponding operation according to the control signaling.

In step 405, when the control signaling is used to control the controllable device to perform a feedback operation of information, the controllable device transmits the feedback information collected according to the control signaling to the communication node on the basis of the point-to-point communication mode.

In step 406, the communication node transmits the feedback information to the multi-mode base station on the basis of the 5G communication mode.

In step 407, the multi-mode base station transmits the feedback information to the terminal.

In some embodiments, after receiving the feedback information, the terminal displays the feedback information.

In the above embodiment, the multi-mode base station can receive the control signaling transmitted by the terminal on the basis of the 5G communication mode, and then transmit the control signaling to the communication node on the basis of the 5G communication mode. Further, the communication node forwards the control signaling to the controllable device on the basis of the point-to-point communication mode. After receiving the control signaling, the controllable device will perform the corresponding operation. When the control signaling is used to control the controllable device to perform a feedback operation of information, the controllable device can transmit the feedback information to the communication node on the basis of the point-to-point communication mode. After the communication node forwards the feedback information to the multi-mode base station on the basis of the 5G communication mode, the multi-mode base station then transmits the feedback information to the terminal. Through the above processes, the purpose of the real-time communication between the terminal and the controllable device is also achieved.

For the foregoing various method embodiments, for the sake of simple description, they are all expressed as a series of action combinations, but those skilled in the art should understand that the present disclosure is not limited by the described action sequence, because according to the present disclosure, certain steps can be performed in other orders or concurrently.

Secondly, those skilled in the art should also understand that the embodiments described in the specification are optional embodiments, and the actions and modules involved are not necessarily required by the present disclosure.

Corresponding to the foregoing method embodiments implementing the application function, the present disclosure also provides an application function implementation apparatus and a corresponding terminal embodiment.

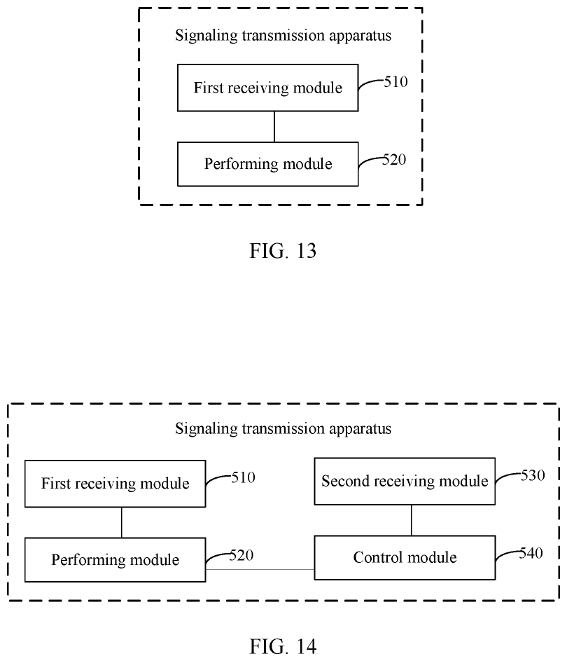

Referring to FIG. 13, which is a block diagram of a signaling transmission apparatus according to some embodiments, the apparatus is used in the controllable device in the above communication network architecture, and the apparatus includes:

a first receiving module 510, configured to receive a control signaling transmitted by a multi-mode base station on the basis of a point-to-point communication mode, wherein the control signaling is a signaling for controlling the controllable device and transmitted by a terminal to the multi-mode base station; and

a performing module 520, configured to perform a corresponding operation according to the control signaling.

Referring to FIG. 14, which is a block diagram showing another signaling transmission apparatus on the basis of the embodiments shown in FIG. 13, the apparatus further includes:

a second receiving module 530, configured to receive a control signaling transmitted by the multi-mode base station to the communication node and forwarded by a communication node in the communication network architecture on the basis of the point-to-point communication mode, wherein the control signaling is a signaling for controlling the controllable device and transmitted by a terminal to the multi-mode base station; and

a control module 540, configured to control the performing module to perform a corresponding operation according to the control signaling after the second receiving module receives the control signaling forwarded by the communication node.

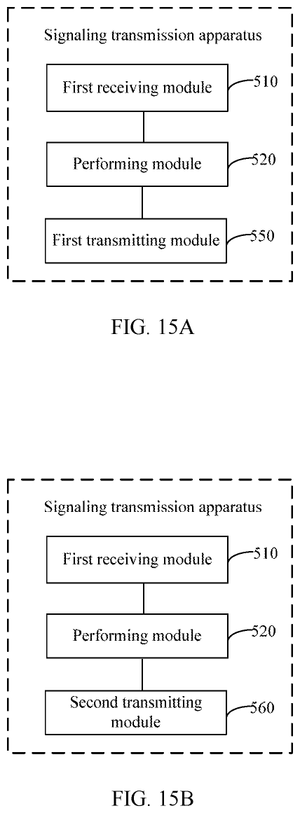

Referring to FIG. 15A, which is a block diagram showing another signaling transmission apparatus on the basis of the embodiments shown in FIG. 13, the apparatus further includes:

a first transmitting module 550, configured to, when the control signaling is used to control the controllable device to perform a feedback operation of information, transmit feedback information collected according to the control signaling to the multi-mode base station on the basis of the point-to-point communication mode, so that the multi-mode base station transmits the feedback information to the terminal.

Referring to FIG. 15B, which is a block diagram showing another signaling transmission apparatus on the basis of the embodiments shown in FIG. 13, the apparatus further includes:

a second transmitting module 560, configured to, when the control signaling is used to control the controllable device to perform a feedback operation of information, transmit the feedback information collected according to the control signaling to the communication node on the basis of the point-to-point communication mode, so that after the communication node transmits the feedback information to the multi-mode base station on the basis of the 5G communication mode, the feedback information is transmitted by the multi-mode base station to the terminal.

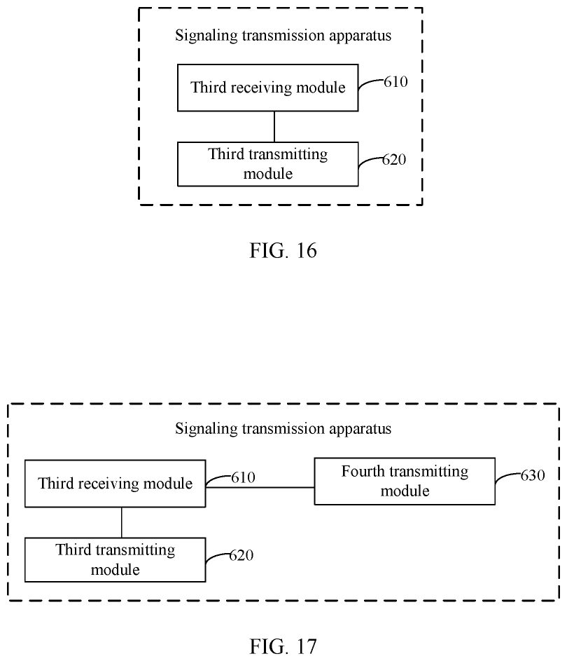

FIG. 16 is a block diagram of another signaling transmission apparatus according to some embodiments, which is used in the multi-mode base station in the above communication network architecture, the apparatus including:

a third receiving module 610, configured to receive a control signaling transmitted by a terminal, wherein the control signaling is a signaling for controlling a controllable device in the communication network architecture; and

a third transmitting module 620, configured to transmit the control signaling to the controllable device on the basis of a point-to-point communication mode, so that the controllable device performs a corresponding operation according to the control signaling.

Referring to FIG. 17, which is a block diagram showing another signaling transmission apparatus on the basis of the embodiments shown in FIG. 16, the apparatus further includes:

a fourth transmitting module 630, configured to transmit the control signaling to a communication node in the network architecture on the basis of a 5G communication mode, so that the communication node forwards the control signaling to the controllable device on the basis of the point-to-point communication mode.

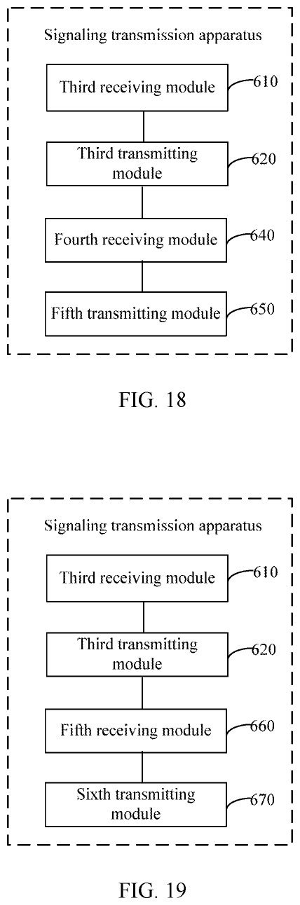

Referring to FIG. 18, which is a block diagram showing another signaling transmission apparatus on the basis of the embodiments shown in FIG. 16, the apparatus further includes:

a fourth receiving module 640, configured to receive the feedback information transmitted by the controllable device to the multi-mode base station on the basis of the point-to-point communication mode, wherein the feedback information is information collected by the controllable device on the basis of the control signaling; and

a fifth transmitting module 650, configured to transmit the feedback information to the terminal.

Referring to FIG. 19, which is a block diagram showing another signaling transmission apparatus on the basis of the embodiments shown in FIG. 16, the apparatus further includes:

a fifth receiving module 660, configured to receive the feedback information forwarded by the communication node in the communication network architectures to the multi-mode base station on the basis of the 5G communication mode, wherein the feedback information is information collected by the controllable device on the basis of the control signaling; and

a sixth transmitting module 670, configured to transmit the feedback information to the terminal.

For the apparatus embodiment, because it basically corresponds to the method embodiment, it can be referred to the description of the method embodiment. The apparatus embodiments described above are merely illustrative, wherein the units described as separate components may or may not be physically separated, and the components displayed as units may or may not be physical units, that is, they may be located in one place, or distributed over a plurality of network elements. Some or all of the modules may be selected according to actual needs to achieve the objectives of the present disclosure. Those skilled in the art can understand and implement the method without any inventive work.

Correspondingly, various embodiments of the present disclosure further provide a computer readable storage medium, wherein the storage medium stores a computer program for executing the signaling transmission method on the controllable device side in the above communication network architecture.

Correspondingly, various embodiments of the present disclosure further provide a computer readable storage medium, wherein the storage medium stores a computer program for executing the signaling transmission method on the multi-mode base station side in the above communication network architecture.

Correspondingly, various embodiments of the present disclosure further provide a signaling transmission apparatus, which is used in the controllable device in the communication network architecture, including:

a processor; and

a memory for storing signalings executable by the processor;

wherein the processor is configured to:

receive a control signaling transmitted by a multi-mode base station on the basis of a point-to-point communication mode, wherein the control signaling is a signaling for controlling the controllable device and transmitted by a terminal to the multi-mode base station; and

perform a corresponding operation according to the control signaling.

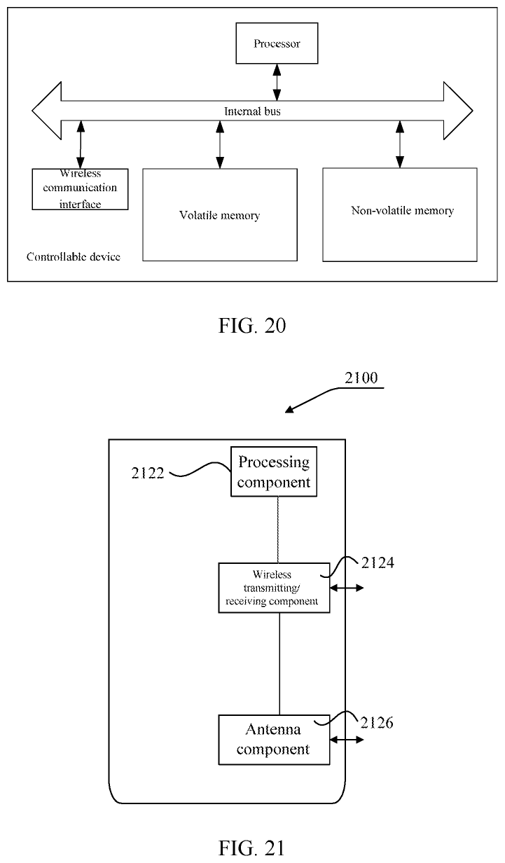

FIG. 20 shows a block diagram of a signaling transmission apparatus 2000 according to some embodiments of the present disclosure. The apparatus 2000 can be provided as a controllable device, such as a robot or a drone.

Referring to FIG. 20, at the hardware level, the device includes a processor, an internal bus, a wireless communication interface, a memory, and a non-volatile memory, and may of course include hardware required for other services. The processor can receive the computer instruction transmitted by the remote controller through the wireless communication interface and then the computer instruction is run on the memory, and the controllable device is formed on the logic level. Of course, this application does not exclude other implementations than software implementations, such as logic devices or combinations of hardware and software, that is, the execution entities of the following processes are not limited to the respective logic units, but may be hardware or logic devices.

Correspondingly, various embodiments of the present disclosure further provide a signaling transmission apparatus, which is used in the multi-mode base station in the communication network architecture, including:

a processor; and

a memory for storing signalings executable by the processor;

wherein the processor is configured to:

receiving a control signaling transmitted by a terminal, wherein the control signaling is a signaling for controlling a controllable device in the communication network architecture; and

transmitting the control signaling to the controllable device on the basis of a point-to-point communication mode, so that the controllable device performs a corresponding operation according to the control signaling.

As shown in FIG. 21, which is a schematic structural diagram of a signaling transmission apparatus 2100 according to some embodiments, the apparatus 2100 may be provided as a multi-mode base station. The multi-mode base station at least supports a 5G communication mode and a point-to-point communication mode. In some embodiments, the multi-mode base station is a common-mode base station of a 5G communication system and a point-to-point communication system.

Referring to FIG. 21, the apparatus 2100 includes a processing component 2122, a wireless transmitting/receiving component 2124, an antenna component 2126, and a signal processing portion specific to the wireless interface. The processing component 2122 may further include one or more processors.

One of the processing components 2322 can be configured to:

receive a control signaling transmitted by a terminal, wherein the control signaling is a signaling for controlling a controllable device in the communication network architecture; and

transmit the control signaling to the controllable device on the basis of a point-to-point communication mode, so that the controllable device performs a corresponding operation according to the control signaling.

The technical solutions provided by the embodiments of the present disclosure can have one or more of the following advantages.

Various embodiments of the present disclosure provide a communication network architecture including at least one controllable device and a multi-mode base station, the multi-mode base station at least supporting a 5G communication mode and a point-to-point communication mode. Further, the controllable device and the multi-mode base station communicate with one another on the basis of the point-to-point communication mode. In the above communication network architecture, the multi-mode base station can perform normal communication with the terminal on the basis of the 5G communication mode, and communicate with the controllable device on the basis of the point-to-point communication mode, thereby providing a solution for a network architecture that performs the communication with the controllable device in combination with the 5G system.

In some embodiments, the multi-mode base station can be a common mode base station of a 5G communication system and a point-to-point communication system. Therefore, on the basis of the existing wireless system, only a small change is required, and a multi-mode base station that communicates with the controllable device in combination with the 5G system can be realized with high availability.

In the communication network architecture provided by various embodiments of the present disclosure, in some embodiments, at least one communication node can be further included, wherein the communication node and the controllable device communicate with one another on the basis of the point-to-point communication mode, and the communication node and the multi-mode base station communicate with one another on the basis of the 5G communication mode. With the above communication network architecture, it is possible to communicate with more controllable devices through different communication nodes at the same time point, which achieves high availability.

In the communication network architecture provided by various embodiments of the present disclosure, a plurality of controllable devices communicates with each other on the basis of the point-to-point communication mode, thereby avoiding collision between controllable devices and better assisting users in locating and coordinating controllable devices, etc.

In some embodiments of the present disclosure, after receiving the control signaling transmitted by the multi-mode base station on the basis of the point-to-point communication mode, the controllable device can perform the corresponding operation according to the control signaling. The control signaling is a signaling for controlling the controllable device and transmitted by the terminal to the multi-mode base station. Through the above processes, the multi-mode base station performs the point-to-point communication with the controllable device directly, thereby realizing the real-time communication with the controllable device in the 5G network system, and further, controlling the controllable device to perform the corresponding operation in real time.

In some embodiments, the controllable device can further perform the corresponding operation according to a control instruction forwarded by the communication node on the basis of the point-to-point communication mode. In the above process, the communication node performs the point-to-point communication with the controllable device, while the communication node performs the 5G communication with the multi-mode base station. The purpose of real-time communication with the controllable device in the 5G network system is also achieved.

In some embodiments of the present disclosure, the controllable device can further transmit the feedback information collected in real time according to the control signaling to the multi-mode base station on the basis of the point-to-point communication mode directly. Or after the controllable device transmits the feedback information to the communication node on the basis of the point-to-point communication mode, the feedback information is transmitted by the communication node to the multi-mode base station on the basis of the 5G communication mode.

Further, the multi-mode base station transmits the feedback information to the terminal. Through the above processes, the feedback information collected by the controllable device can be transmitted to the terminal in real time in the 5G system.

In some embodiments of the present disclosure, after receiving the control signaling transmitted by the terminal, the multi-mode base station can transmit the control signaling to the controllable device on the basis of the point-to-point communication mode, so that the controllable device can perform the corresponding operation according to the control signaling. Through the above processes, real-time communication with the controllable device is realized in the 5G system, and further, real-time control of the controllable device can be realized through the terminal.

In the present disclosure, it is to be understood that the terms “lower,” “upper,” “center,” “longitudinal,” “transverse,” “length,” “width,” “thickness,” “upper,” “lower,” “front,” “back,” “left,” “right,” “vertical,” “horizontal,” “top,” “bottom,” “inside,” “outside,” “clockwise,” “counterclockwise,” “axial,” “radial,” “circumferential,” “column,” “row,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

In the present disclosure, the terms “installed,” “connected,” “coupled,” “fixed” and the like shall be understood broadly, and may be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the present disclosure, a first element being “on,” “over,” or “below” a second element may indicate direct contact between the first and second elements, without contact, or indirect through an intermediate medium, unless otherwise explicitly stated and defined.

Moreover, a first element being “above,” “over,” or “at an upper surface of” a second element may indicate that the first element is directly above the second element, or merely that the first element is at a level higher than the second element. The first element “below,” “underneath,” or “at a lower surface of” the second element may indicate that the first element is directly below the second element, or merely that the first element is at a level lower than the second feature. The first and second elements may or may not be in contact with each other.

In the description of the present disclosure, the terms “one embodiment,” “some embodiments,” “example,” “specific example,” or “some examples,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

In some embodiments, the control and/or interface software or app can be provided in a form of a non-transitory computer-readable storage medium having instructions stored thereon is further provided. For example, the non-transitory computer-readable storage medium may be a Read-Only Memory (ROM), a Random-Access Memory (RAM), a Compact Disc Read-Only Memory (CD-ROM), a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures. For example, the devices can be controlled remotely through the Internet, on a smart phone, a tablet computer or other types of computers, with a web-based graphic user interface (GUI).

A computer program (also known as a program, software, software application, app, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode) display, other flexible configuration, or any other monitor for displaying information to the user and a keyboard, a pointing device, e.g., a mouse, trackball, etc., or a touch screen, touch pad, etc., by which the user can provide input to the computer.

Other types of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In an example, a user can speak commands to the audio processing device, to perform various operations.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A communication network comprising:
at least one controllable device; and
a multi-mode base station, the multi-mode base station at least supporting a 5G communication mode and a point-to-point communication mode;
wherein the controllable device and the multi-mode base station communicate with one another on the basis of the point-to-point communication mode.

2. The communication network according to claim 1, wherein the multi-mode base station is a common mode base station of a 5G communication system and a point-to-point communication system.

3. The communication network according to claim 1, wherein the communication network architecture further comprises at least one communication node,
wherein the communication node and the controllable device communicate with one another on the basis of the point-to-point communication mode; and
the communication node and the multi-mode base station communicate with one another on the basis of the 5G communication mode.

4. The communication network according to claim 3, wherein the communication node and the controllable device communicate with one another by using a wireless communication frequency band corresponding to the 5G communication system.

5. The communication network according to claim 3, wherein the communication node and the multi-mode base station communicate with one another through a preset communication interface.

6. The communication network according to claim 1, wherein when the number of the controllable devices is multiple, the controllable devices communicate with each other on the basis of the point-to-point communication mode.

7. A signaling transmission apparatus for use in a controllable device in a communication network architecture, comprising:
a processor; and
a memory for storing signalings executable by the processor;
wherein the processor is configured to:
receive a control signaling transmitted by a multi-mode base station on the basis of a point-to-point communication mode, wherein the control signaling is a signaling for controlling the controllable device and transmitted by a terminal to the multi-mode base station; and
perform a corresponding operation according to the control signaling.

8. The apparatus according to claim 7, wherein the processor is further configured to:
receive the control signaling transmitted by the multi-mode base station to a communication node and forwarded by the communication node in the communication network architecture on the basis of the point-to-point communication mode, wherein the control signaling is a signaling for controlling the controllable device and transmitted by the terminal to the multi-mode base station; and
control the performing module to perform a corresponding operation according to the control signaling after the second receiving module receives the control signaling forwarded by the communication node.

9. The apparatus according to claim 7, wherein the processor is further configured to:
when the control signaling is used to control the controllable device to perform a feedback operation of information, transmit feedback information collected according to the control signaling to the multi-mode base station on the basis of the point-to-point communication mode, so that the multi-mode base station transmits the feedback information to the terminal;
when the control signaling is used to control the controllable device to perform a feedback operation of information, transmit the feedback information collected according to the control signaling to the communication node on the basis of the point-to-point communication mode, so that after the communication node transmits the feedback information to the multi-mode base station on the basis of the 5G communication mode, the feedback information is transmitted by the multi-mode base station to the terminal.

10. A signaling transmission apparatus, wherein the apparatus is used in a multi-mode base station in a communication network architecture, the apparatus comprising:
a processor; and
a memory for storing signalings executable by the processor;
wherein the processor is configured to:
receiving a control signaling transmitted by a terminal, wherein the control signaling is a signaling for controlling a controllable device in the communication network architecture; and
transmitting the control signaling to the controllable device on the basis of a point-to-point communication mode, so that the controllable device performs a corresponding operation according to the control signaling.

11. The apparatus according to claim 10, wherein the processor is further configured to:
transmit the control signaling to a communication node in the network architecture on the basis of a 5G communication mode, so that the communication node forwards the control signaling to the controllable device on the basis of the point-to-point communication mode.

12. The apparatus according to claim 10, wherein the processor is further configured to:
receive feedback information transmitted by the controllable device to the multi-mode base station on the basis of the point-to-point communication mode, wherein the feedback information is information collected by the controllable device on the basis of the control signaling; and
transmit the feedback information to the terminal.

13. The apparatus according to claim 10, wherein the processor is further configured to:
receive the feedback information forwarded by the communication node in the communication network architectures to the multi-mode base station on the basis of the 5G communication mode, wherein the feedback information is information collected by the controllable device on the basis of the control signaling; and
transmit the feedback information to the terminal.

14. The communication network according to claim 2, wherein when the number of the controllable devices is multiple, the controllable devices communicate with each other on the basis of the point-to-point communication mode.

15. The communication network according to claim 3, wherein when the number of the controllable devices is multiple, the controllable devices communicate with each other on the basis of the point-to-point communication mode.

16. The communication network according to claim 4, wherein when the number of the controllable devices is multiple, the controllable devices communicate with each other on the basis of the point-to-point communication mode.

17. The communication network according to claim 5, wherein when the number of the controllable devices is multiple, the controllable devices communicate with each other on the basis of the point-to-point communication mode.

18. The communication network according to claim 1, further comprising a plurality of controllable devices communicating with each other in the point-to-point communication mode, thereby avoiding conflicts between the plurality of controllable devices and better assisting users in locating and coordinating the plurality of controllable devices.

19. The communication network according to claim 1, wherein:
the controllable device is configured to, after receiving the control signaling transmitted by the multi-mode base station on the basis of the point-to-point communication mode, perform the corresponding operation according to the control signaling;
the control signaling is a signaling for controlling the controllable device and transmitted by a terminal to the multi-mode base station;
the multi-mode base station is configured to perform the point-to-point communication with the controllable device directly, thereby realizing real-time communication with the controllable device in the 5G network system, and controlling the controllable device to perform the corresponding operation in real time.

20. The communication network according to claim 2, wherein:
the controllable device is an unmanned aerial system (UAS) configured perform the corresponding operation according to a control instruction forwarded by the communication node on the basis of the point-to-point communication mode;
the communication node is configured to perform the point-to-point communication with the controllable device, while the communication node performs the 5G communication with the multi-mode base station, thereby realizing real-time communication with the controllable device in the 5G network system is also achieved;
the controllable device is further configured to transmit the feedback information collected in real time according to the control signaling to the multi-mode base station on the basis of the point-to-point communication mode directly; or after the controllable device transmits the feedback information to the communication node on the basis of the point-to-point communication mode, the feedback information is transmitted by the communication node to the multi-mode base station on the basis of the 5G communication mode;
the multi-mode base station is configured to transmit the feedback information to the terminal, and the feedback information collected by the controllable device is transmitted to the terminal in real time in the 5G system;
the multi-mode base station is further configured to, after receiving the control signaling transmitted by the terminal, transmit the control signaling to the controllable device on the basis of the point-to-point communication mode, such that the controllable device performs the corresponding operation according to the control signaling; thereby realizing real-time communication with the controllable device in the 5G system and real-time control of the controllable device through the terminal.
